(19) United States
(12) Patent Application Publication
(10) Pub. No.: US 2026/0129729 A1
(43) Pub. Date: May 7, 2026

(54) CONSTANT CURRENT DRIVING CIRCUIT, CONSTANT CURRENT CONTROL SYSTEM AND LAMP

(71) Applicants: SUZHOU OPPLE LIGHTING CO., LTD., Suzhou City (CN); OPPLE LIGHTING CO., LTD., Shanghai (CN)

(72) Inventors: Xiaobing SUN, Suzhou City (CN); Feng CHEN, Suzhou City (CN); Jianping HAN, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 19/434,095

(22) Filed: Dec. 29, 2025

Related U.S. Application Data
(63) Continuation of application No. PCT/CN2024/100278, filed on Jun. 20, 2024.

(30) Foreign Application Priority Data
Jun. 29, 2023 (CN) 202310789354.8
Jun. 29, 2023 (CN) 202321686484.0

(51) Int. Cl. H05B 45/345; H05B 45/31; H05B 45/36; H05B 45/3725; H05B 45/50; H05B 47/28

(52) U.S. Cl. CPC H05B 45/345; H05B 45/31; H05B 45/36; H05B 45/3725; H05B 45/50; H05B 47/28

(57) ABSTRACT

The present disclosure provides a constant current drive circuit, a constant current control system, and a lamp. The constant current drive circuit includes a load module, a start-stop module for controlling the starting and stopping of the load module, an energy storage module, and a rectifier module for controlling the current angle and current magnitude of the load module circuit. The energy storage module can charge when the load module is input with a high voltage and discharge when the load module is input with a low voltage. The rectifier module includes a resistor R1, a first compensation circuit, a first reference circuit, a first comparator, and a field-effect transistor M1 connected, the drain electrode and the source electrode of the field-effect transistor M1 are connected to the energy storage module and the resistor R3.

### CROSS-REFERENCE TO RELATED APPLICATIONS

This disclosure is based upon and claims the priority of PCT patent disclosure No. PCT/CN2024/100278 filed on Jun. 20, 2024, which claims priority to the Chinese patent disclosure No. 202310789354.8 filed on Jun. 29, 2023 and the Chinese patent disclosure No. 202321686484.0 filed on Jun. 29, 2023, the entire contents of which are hereby incorporated by reference herein for all purposes.

### TECHNICAL FIELD

The present disclosure relates to a constant current drive circuit, a constant current control system, and a lamp, which belong to the technical field of integrated circuits.

### BACKGROUND

With the release of the new national standard GB 17625.1-2022 “Electromagnetic Compatibility Limits—Part 1: Limits for Harmonic Current Emissions (Equipment Input Current per Phase≤16 A)”, most lamps involving multi-stage high-voltage linearity in lighting equipment fail to meet the emission limit of rated power≤25 W.

### SUMMARY

The present disclosure provides a constant current drive circuit, a constant current control system, and a lamp.

The present disclosure provides a constant current drive circuit, and this constant current drive circuit may include:
a load module;
a start-stop module that may be connected to an output terminal of the load module to control start and stop of the load module;
an energy storage module that may be connected to an input terminal of the load module to be charged when a first voltage (for example, a high voltage) is input to the load module and be discharged when a second voltage (for example, a low voltage) is input to the load module; and
a rectifier module that may be connected to an output terminal of the energy storage module to control a current angle and current magnitude of a current flowing through the energy storage module;
where the rectifier module includes a resistor R1, a first compensation circuit, a first reference circuit, a first comparator, a field-effect transistor M1, and a resistor R3, an input terminal of the resistor R1 is connected to the output terminal of the load module, and an output terminal of the resistor is connected to an input terminal of the first compensation circuit, an output terminal of the first compensation circuit is connected to an input terminal of the first reference circuit, and an output terminal of the first reference circuit is connected to a non-inverting input terminal of the first comparator, an output terminal of the first comparator is connected to a gate electrode of the field-effect transistor M1, a drain electrode of the field-effect transistor M1 is connected to the energy storage module, a source electrode of the field-effect transistor M1 is connected to an inverting input terminal of the first comparator and an input terminal of the resistor R3, an output terminal of the resistor R3 is connected to the output terminal of the load module and grounded, to control a current peak value of the energy storage module through the resistor R3.

The present disclosure also provides a constant current control system, and the system may include: a drive module, a chip, and the above constant current drive circuit, the resistor R1 is connected to a pin VT1 of the chip, and the resistor R3 is connected to a pin CS of the chip, one terminal of the energy storage module is connected to an output terminal of the drive module, and the other terminal is connected to a pin CH of the chip, the load module includes a first load, a second load, and a resistor, an input terminal of the first load is connected to the drive module, and an output terminal of the first load is respectively connected to an input terminal of the second load and a pin OUT1 of the chip, an output terminal of the second load is connected to a pin OUT2 of the chip, and the resistor is connected to a pin REXT of the chip, the start-stop module includes a resistor R2, an input terminal of the resistor R2 is connected to the output terminal of the drive module, and the output terminal of the resistor R2 is respectively connected to a filter capacitor C1 and a pin VT2 of the chip.

Further, the present disclosure provides a lamp, including the above constant current drive circuit, and the load module may be an LED lamp.

It is to be understood that both the foregoing general description and the following detailed description are exemplary and explanatory only and are not restrictive of the present disclosure.

### BRIEF DESCRIPTION OF DRAWINGS

FIG. 1 is a circuit diagram of a drive control system according to an example of the present disclosure.

FIG. 2 is an internal circuit diagram of a chip in FIG. 1.

### DETAILED DESCRIPTION

To make the objectives, technical solutions, and advantages of the present disclosure clearer, the present disclosure will be described in detail below with reference to the accompanying drawings and examples.

Reference Numerals used in this disclosure may include:

Constant current control system 100, constant current drive circuit 200, load module 1, first load 11, second load 12, resistor 13, energy storage module 2, electrolytic capacitor E1, resistor R4, rectifier module 3, resistor R1, first compensation circuit 31, first reference circuit 32, first comparator 33, field-effect transistor M1, resistor R3, first power supply circuit 34, first protector 35, start-stop module 4, resistor R2, filter capacitor C1, second compensation circuit 41, second reference circuit 42, second switch circuit 43, field-effect transistor M2, second comparator 431, third switch circuit 44, third comparator 441, field-effect transistor M3, second protector 45, second power supply circuit 46, drive module 5, rectifier bridge 51, diode D1, chip 6.

Although some products are designed using a single-stage high-voltage linearity solution that complies with the standard, single-stage high-voltage linearity products may fail to work normally when the voltage is low or fluctuates significantly. Similarly, existing multi-stage high-voltage linearity products also experience flickering or failure to work when the voltage is low or fluctuates; furthermore, existing multi-stage high-voltage linearity products cannot meet the requirements for phase angle and THD (Total Harmonic Distortion) specified in the new national standard.

In view of this, it is necessary to propose a constant current drive circuit, a constant current control system, and a lamp to solve the above-mentioned problems.

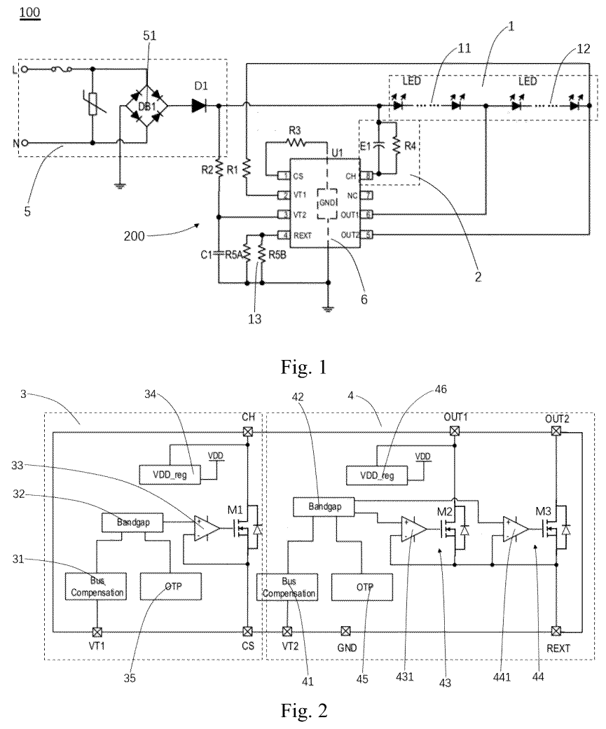

Referring to FIG. 1 and FIG. 2, the present disclosure discloses a constant current drive circuit 200, which is used to adjust the phase angle and peak value of the output current of the circuit. This enables the constant current drive circuit 200 to comply with the new national standard, thereby allowing products applying this circuit to be successfully launched on the market and meet consumers'demands.

The constant current drive circuit 200 includes a load module 1, a start-stop module 4, an energy storage module 2, and a rectifier module 3. Specifically, the start-stop module 4 is connected to the output terminal of the load module 1 to control the start and stop of the load module 1; the energy storage module 2 is connected to the input terminal of the load module 1 to be charged when a first voltage (for example, a high voltage) is input to the load module 1 and be discharged when a second voltage (for example, a low voltage) is input to the load module 1, so as to maintain the normal operation of the load module 1 of the circuit and improve the operational stability of the product; the first voltage is higher than the second voltage; the rectifier module 3 is connected to the output terminal of the energy storage module 2 to control the current angle and current peak of the current flowing through the energy storage module 2.

Specifically, the rectifier module 3 includes a resistor R1, a first compensation circuit 31, a first reference circuit 32, a first comparator 33, a field-effect transistor M1, and a resistor R3. The input terminal of the resistor R1 is connected to the output terminal of the load module 1, and the output terminal of the resistor R1 is connected to the input terminal of the first compensation circuit 31. The output terminal of the first compensation circuit 31 is connected to the input terminal of the first reference circuit 32, and the output terminal of the first reference circuit 32 is connected to the non-inverting input terminal of the first comparator 33. The output terminal of the first comparator 33 is connected to the gate electrode of the field-effect transistor M1, and the drain electrode of the field-effect transistor M1 is connected to the energy storage module 2. The source electrode of the field-effect transistor M1 is respectively connected to the inverting input terminal of the first comparator 33 and the input terminal of the resistor R3. The output terminal of the resistor R3 is connected to the output terminal of the load module 1 and grounded, so as to control the current peak of the energy storage module 2 through the resistor R3.

With this configuration, when the voltage across two terminals of the load module 1 increases, the rectifier module 3 can detect the voltage of the load module 1 through the voltage difference of the two terminals of the resistor R1. Simultaneously, the first compensation circuit 31 controls the first reference circuit 32 to generate different reference voltages, which are compared by the first comparator 33 to further control the on and of state of the field-effect transistor M1, thereby controlling the current phase of the energy storage module 2. Specifically, adjusting the resistance value of the resistor R1 to change the voltage difference of the two terminals of the resistor R1, thereby modifying the reference voltage of the first reference circuit 32 to achieve current angle adjustment.

The resistor R3 is connected in series with the energy storage module 2. By adjusting the resistance value of the resistor R3, the maximum current flowing through the resistor R3 (i.e., the peak current) can be adjusted, thereby enabling adjustment of the peak current of the energy storage module 2.

The energy storage module 2 includes an electrolytic capacitor E1 and a resistor R4 connected in parallel with the electrolytic capacitor E1. The positive electrode of the electrolytic capacitor E1 is connected to the input terminal of the load module 1, and the negative electrode of the electrolytic capacitor E1 is connected to the drain electrode of the field-effect transistor M1. The resistance value of the resistor R1 is adjusted to control the on and off state of the field-effect transistor M1, thereby changing the current angle during the charging and discharging of the electrolytic capacitor E1.

The rectifier module 3 further includes a temperature protector connected to the first reference circuit 32. The temperature protector can detect the using temperature of the constant current drive circuit 200. When the temperature is relatively high, the temperature protector controls the first reference circuit 32 to further control the output power of the constant current drive circuit 200, reducing the output power to cool down the constant current drive circuit 200. This achieves the protection of the constant current drive circuit 200 and prevents abnormalities in the constant current drive circuit 200 caused by high temperatures.

The load module 1 includes a first load 11, a second load 12, and a resistor 13 connected in series. The input terminal of the energy storage module 2 is connected to the input terminal of the first load 11. The resistor R1 is connected to the output terminal of the second load 12. The input terminal of the resistor 13 is respectively connected to the output terminals of the first load 11 and the second load 12, and the output terminal of the resistor 13 is grounded. By connecting the input terminal of the energy storage module 2 to the input terminal of the first load 11, the energy storage module 2 can supply power to the load module 1 when the voltage of the load module 1 is low, thereby maintaining the normal operation of the load module 1. The arrangement of the resistor 13 enables the control for the current of the load module 1.

In this example, there are two resistors 13 that are connected in parallel, the two resistors 13 are designated as a resistor R5A and a resistor R5B, and are used to control the heat generation of the resistor 13. Certainly, in other examples, there may be a single resistor 13, or three or five parallel-connected resistors, etc. The configuration is not limited here, as long as it enables control over the heat generation of the resistor 13 and ensures the normal operation of the resistor 13.

The start-stop module 4 includes a resistor R2, a filter capacitor C1, a second compensation circuit 41, a second reference circuit 42, a second switching circuit 43, and a third switching circuit 44. The input terminal of the resistor R2 is connected to the input terminal of the load module 1, the output terminal of the resistor R2 is connected to the input terminals of the second compensation circuit 41 and the filter capacitor C1. The output terminal of the filter capacitor C1 is grounded. The second compensation circuit 41 is connected to the second reference circuit 42. The input terminal of the second switching circuit 43 is connected to the output terminal of the first load 11, and the output terminal of the second switching circuit 43 is connected to the resistor 13, to control the start and stop of the first load 11. The input terminal of the third switching circuit 44 is connected to the output terminal of the second load 12, and the output terminal of the third switching circuit 44 is connected to the resistor 13, to control the start and stop of the second load 12. The second reference circuit 42 generates a reference voltage, which is supplied to the second switching circuit 43 and the third switching circuit 44 to independently control the start and stop of the first load 11 and the second load 12, respectively.

By incorporating the filter capacitor C1 at the output terminal of the resistor R2, the filter capacitor C1 can be charged and discharged during the operation of the constant current drive circuit 200, the reference voltage generated by the second reference circuit 42 is adjusted, thereby controlling the first switching circuit and the second switching circuit 43 to achieve the start and stop of the second load 12.

The second switching circuit 43 includes a second comparator 431 and a field-effect transistor M2. The second reference circuit 42 is connected to the non-inverting input terminal of the second comparator 431. The source electrode of the field-effect transistor M2 is connected to the resistor 13 and the inverting input terminal of the second comparator 431, and the drain electrode of the field-effect transistor M2 is connected to the output terminal of the first load 11. The second comparator 431 controls the on and off state of the field-effect transistor M2 to control the start and stop of the first load 11. Specifically, the second comparator 431 can generate a comparator reference and compares it with the reference voltage generated by the second reference circuit 42. Based on this comparison, the second comparator 431 determines whether to turn the field-effect transistor M2 on or off, thereby controlling the start and stop of the first load 11.

Similarly, the third switching circuit 44 includes a third comparator 441 and a field-effect transistor M3. The second reference circuit 42 is connected to the non-inverting input terminal of the third comparator 441. The source electrode of the field-effect transistor M3 is connected to the resistor 13 and the inverting input terminal of the third comparator 441, and the drain electrode of the field-effect transistor M3 is connected to the output terminal of the second load 12. The third comparator 441 controls the on and off state of the field-effect transistor M3 to control the start and stop of the second load 12. Specifically, the third comparator 441 can generate a comparator reference and compares it with the reference voltage generated by the second reference circuit 42. Based on this comparison, the third comparator 441 determines whether to turn the field-effect transistor M3 on or off, thereby controlling start and stop of the second load 12.

In this example, the reference value of the second comparator 431 is lower than the reference value of the third comparator 441. This configuration enables the reference voltage generated by the second reference circuit 42 to control the circuit such that only the field-effect transistor M2 is turned on, or both the field-effect transistor M2 and the field-effect transistor M3 are turned on. When the voltage is relatively high, the second load 12 is connected to divide the voltage of the first load 11, thereby preventing the first load 11 from breakdown due to excessive voltage.

The constant current drive circuit 200 may further include a drive module 5 to supply power to the load module 1 and drive the operation of the load module 1. The drive module 5 includes a rectifier bridge 51 connected to a wire network and a diode D1. The output terminal of the rectifier bridge 51 is connected to the input terminal of the diode D1, the output terminal of the diode D1 is connected to the resistor R2, the energy storage module 2, and the load module 1.

In this example, the specific circuit configurations of the first compensation circuit 31, the first reference circuit 32, the first protector 35, the second compensation circuit 41, the second reference circuit 42, and the second protector 45 may be implemented according to existing technical standards, which are not limited here.

Overall, the technical solution of the present disclosure includes four circuits: the charging circuit of the electrolytic capacitor E1, the discharging circuit of the electrolytic capacitor E1, the operation circuit of the first load 11, and the operation circuit of both the first load 11 and the second load 12. Specifically, when the voltage of the rectifier bridge 51 is high, the operation circuit of both the first load 11 and the second load 12 and the charging circuit of the electrolytic capacitor E1 are connected. When the voltage of the rectifier bridge 51 approaches the operation voltage of the first load 11, only the operation circuit of the first load 11 is connected. When the voltage of the rectifier bridge 51 is low, the discharging circuit of the electrolytic capacitor E1 is connected.

Specifically, in the charging circuit of the electrolytic capacitor E1, current output from the rectifier bridge 51 flows through the diode D1 and subsequently branches to the electrolytic capacitor E1, the first load 11, and the second load 12. The current passing through the second load 12 then flows to the resistor R1, generating a voltage difference across the resistor R1, and controlling the on and off state of the field-effect transistor M1 through the first compensation circuit 31, the first reference circuit 32, and the first comparator 33. The negative electrode of the electrolytic capacitor E1 is connected to ground through the field-effect transistor M1 and the resistor R3, thereby forming a complete circuit for the electrolytic capacitor E1 to achieve charging of the electrolytic capacitor E1.

In the discharging circuit of the electrolytic capacitor, the current is output from the positive electrode of the electrolytic capacitor E1 and then flows through the first load 11 and/or the second load 12, then passes through the resistor 13 and the resistor R3, and finally flows to the negative electrode of the electrolytic capacitor E1 through the field-effect transistor M1. This forms a power supply circuit where the electrolytic capacitor E1 supplies power to the first load 11 and/or the second load 12. When the voltage of the rectifier bridge 51 is low, this configuration enables the electrolytic capacitor E1 to supply power to the load module 1, thereby maintaining the normal operation of the load module 1.

In the operation circuit of the first load 11, the current output from the rectifier bridge 51 flows to the resistor R2 and the first load 11. The current passing through the resistor R2 then outputs to the second compensation circuit 41 and the second reference circuit 42. Through the action of the second reference circuit 42, the second switching circuit 43 is turned on while the third switching circuit 44 remains off. This configuration enables the first load 11 to be connected while the second load 12 is disconnected. The current flowing through the first load 11 passes through the field-effect transistor M2 and then is grounded through the resistor 13, thereby completing the operation circuit of the first load 11.

In the operation circuit of both the first load 11 and the second load 12, the second reference circuit 42 controls both the second switching circuit 43 and the third switching circuit 44 to be connected. This enables both the first load 11 and the second load 12 to be connected. The current flows through the first load 11, the second load 12, and the resistor 13 and then is grounded, thereby forming the operation circuit of both the first load 11 and the second load 12.

Please refer to FIG. 1 and FIG. 2, the present disclosure further provides a constant current control system 100, which includes a drive module 5, a chip 6, and the aforementioned constant current drive circuit 200. By integrating some components of the constant current control circuit into the chip 6, the integration level of the constant current control system 100 is enhanced while simultaneously reducing the manufacturing cost of the constant current control system 100.

Specifically, the resistor R1 is connected to a pin VT1 of the chip 6, the resistor R3 is connected to a pin CS of the chip 6. One terminal of the energy storage module 2 is connected to the output terminal of the drive module 5, and the other terminal of the energy storage module 2 is connected to a pin CH of the chip 6. The first compensation circuit 31, the first reference circuit 32, the first comparator 33, and the field-effect transistor M1 in the rectifier module 3 are all integrated in the chip 6. One terminal of the first compensation circuit 31 is connected to a pin VT1 of the chip 6, and the other terminal of the first compensation circuit 31 is connected to the first reference circuit 32. The first reference circuit 32 is connected to the non-inverting input of the first comparator 33, the first comparator 33 is connected to the gate electrode of the field-effect transistor M1. The source electrode of the field-effect transistor M1 is connected to the inverting input of the first comparator 33 and a pin CS of the chip 6, and the drain electrode of the field-effect transistor M1is connected to a pin CH of the chip 6.

Specifically, the rectifier module 3 further includes a first power supply circuit 34 and a first protector 35 integrated in the chip 6. One terminal of the first power supply circuit 34 is connected to a CH pin of the chip 6, and the other terminal of the first power supply circuit 34 is connected to the chip 6 to provide operation power to the chip 6. The first protector 35, implemented as a temperature protector, is arranged in the chip 6 and connected to the first reference circuit 32 to prevent chip damage caused by excessive temperature. Preferably, the chip 6 includes a GND terminal, the resistor R3 is connected to the CS pin and the GND terminal of the chip 6, thereby achieving grounding of the resistor R3.

The load module 1 includes a first load 11, a second load 12, and a resistor 13. The input terminal of the first load 11 is connected to the drive module 5, the output terminal of the first load 11 is respectively connected to the input terminal of the second load 12 and the pin OUT1 of the chip 6. The output terminal of the second load 12 is connected to the pin OUT2 of the chip 6. The resistor 13 is connected to the pin REXT of the chip 6. The start-stop module 4 includes a resistor R2, the input terminal of the resistor R2 is connected to the output terminal of the drive module 5, and the output terminal of the resistor R2 is respectively connected to the filter capacitor C1 and the pin VT2 of the chip 6.

The second compensation circuit 41, the second reference circuit 42, and the second switch circuit 43 in the start-stop module 4 are all integrated in the chip 6. One terminal of the second compensation circuit 41 is connected to the pin VT2 of the chip 6, and the other terminal of the second compensation circuit 41 is connected to the second reference circuit 42. The second reference circuit 42 is respectively connected to the non-inverting inputs of the second comparator 431 and the third comparator 441. The second comparator 431 is connected to the gate electrode of the field-effect transistor M2, the source electrode of the field-effect transistor M2 is connected to the inverting input of the second comparator 431 and the pin REXT of the chip 6, and the drain electrode of the field-effect transistor M2 is connected to the pin OUT1 of the chip 6. The third comparator 441 is connected to the gate electrode of the field-effect transistor M3, the source electrode of the field-effect transistor M3 is connected to the inverting input of the second comparator 431 and the pin REXT of the chip 6, and the drain electrode of the field-effect transistor M3 is connected to the pin OUT2 of the chip 6.

Specifically, the start-stop module 4 further includes a second power supply circuit 46 and a second protector 45 disposed in the chip 6. One terminal of the second power supply circuit 46 is connected to the pin OUT1 of the chip 6, and the other terminal of the second power supply circuit 46 is connected to the chip 6 to supply power to the chip 6. The second protector 45 is a temperature protector, which is arranged in the chip 6 and connected to the second reference circuit 42 to prevent damage to the chip 6 caused by excessive temperature.

The drive module 5 includes a rectifier bridge 51 connected to the wire network and a diode D1. The output terminal of the rectifier bridge 51 is connected to the input terminal of the diode D1, and the output terminal of the diode D1 is respectively connected to the resistor R2, the energy storage module 2, and the load module 1. By arranging the diode D1, the current of the rectifier bridge 51 can flow through the diode D1 to the energy storage module 2 and the load module 1; when the energy storage module 2 discharges, the current cannot flow through the diode D1 to the rectifier bridge 51.

The present disclosure further provides a lamp, which includes a base, a frame, a lampshade, a circuit board provided with the aforementioned constant current drive circuit 200, etc. The load module 1 is an LED lamp, the first load 11 is a first lamp string, and the second load 12 is a second lamp string. The circuit board is further provided with a drive module 5, which is assembled on the circuit board and connected to an external wire network to convert the alternating current of the wire network into direct current for powering the constant current drive circuit 200. In other examples, a constant current control system 100 may be arranged on the circuit board; by integrating part of the structures of the constant current drive circuit 200 into the chip 6, the integration level of the circuit board is improved, thereby reducing the cost of the circuit board, which is not limited herein.

In this example, the lamp includes but is not limited to downlights, bulb lights, light-emitting modules, ceiling lights, street lights, industrial and mining lights, etc. In other examples, the constant current control system 100 and the constant current drive circuit 200 can also be arranged in products in other electronic fields, which is not limited herein.

In summary, the constant current drive circuit 200 of the present disclosure adjusts the current peak value and current phase angle of the electrolytic capacitor E1 during charging or discharging through the rectifier module 3, enabling the output current of the constant current drive circuit 200 to meet the requirements for phase angle and THD specified in the new national standards. By adjusting the resistance value of the resistor R1, the on or off time of the field-effect transistor M1 is changed, thereby adjusting the phase angle of the electrolytic capacitor E1. By adjusting the resistance value of the resistor R3, the adjustment of the current peak value of the electrolytic capacitor E1 is realized. By arranging the first protector 35 and the second protector 45, the safety of the constant current control system 100 is improved.

The purpose of the present disclosure is to provide a constant current drive circuit, a constant current control system, and a lamp, so as to address the problems in the other implementations where multi-stage high-voltage linearity products may fail to work when voltage fluctuates, and fail to meet the requirements for phase angle and THD specified in the new national standard.

To achieve the above purpose, the present disclosure provides a constant current drive circuit, including:
a load module;
a start-stop module, connected to an output terminal of the load module to control start and stop of the load module;
an energy storage module, connected to an input terminal of the load module to be charged when a first voltage (for example, a high voltage) is input to the load module and be discharged when a second voltage (for example, a low voltage) is input to the load module; and
a rectifier module, connected to an output terminal of the energy storage module to control a current angle and current magnitude of a current flowing through the energy storage module;
where the rectifier module includes a resistor R1, a first compensation circuit, a first reference circuit, a first comparator, a field-effect transistor M1, and a resistor R3, an input terminal of the resistor R1 is connected to the output terminal of the load module, and an output terminal of the resistor is connected to an input terminal of the first compensation circuit, an output terminal of the first compensation circuit is connected to an input terminal of the first reference circuit, and an output terminal of the first reference circuit is connected to a non-inverting input terminal of the first comparator, an output terminal of the first comparator is connected to a gate electrode of the field-effect transistor M1, a drain electrode of the field-effect transistor M1 is connected to the energy storage module, a source electrode of the field-effect transistor M1 is respectively connected to an inverting input terminal of the first comparator and an input terminal of the resistor R3, an output terminal of the resistor R3 is connected to the output terminal of the load module and grounded, to control a current peak value of the energy storage module through the resistor R3.

Optionally, the energy storage module includes an electrolytic capacitor E1 and a resistor R4 connected in parallel with the electrolytic capacitor E1, a positive electrode of the electrolytic capacitor E1 is connected to the input terminal of the load module, and a negative electrode of the electrolytic capacitor E1 is connected to the drain electrode of the field-effect transistor M1, a resistance value of the resistor R1 is adjusted to control on and off state of the field-effect transistor M1, to change a current angle of the electrolytic capacitor E1 during charging and discharging.

Optionally, the rectifier module further includes a temperature protector connected to the first reference circuit.

Optionally, the load module includes a first load, a second load, and a resistor connected in series, the input terminal of the energy storage module is connected to an input terminal of the first load, the resistor R1 is connected to an output terminal of the second load, an input terminal of the resistor is respectively connected to output terminals of the first load and the second load, and an output terminal of the resistor is grounded.

Optionally, the start-stop module includes a resistor R2, a filter capacitor C1, a second compensation circuit, a second reference circuit, a second switch circuit, and a third switch circuit, an input terminal of the resistor R2 is connected to the input terminal of the load module, and an output terminal of the resistor R2 is respectively connected to input terminals of the filter capacitor C1 and the second compensation circuit, an output terminal of the filter capacitor C1 is grounded, the second compensation circuit is connected to the second reference circuit, an input terminal of the second switch circuit is connected to an output terminal of the first load, and an output terminal of the second switch circuit is connected to the resistor to control start and stop of the first load, an input terminal of the third switch circuit is connected to the output terminal of the second load, and an output terminal of the third switch circuit is connected to the resistor to control start and stop of the second load, the second reference circuit generates a reference voltage and inputs the reference voltage to the second switch circuit and the third switch circuit to respectively control start and stop of the first load and the second load.

Optionally, the second switch circuit includes a second comparator and a field-effect transistor M2, the second reference circuit is connected to a non-inverting input terminal of the second comparator, a source electrode of the field-effect transistor M2 is respectively connected to the resistor and an inverting input terminal of the second comparator, a drain electrode of the field-effect transistor M2 is connected to the output terminal of the first load, and the second comparator controls on and off state of the field-effect transistor M2 to control start and stop of the first load.

Optionally, the third switch circuit includes a third comparator and a field-effect transistor M3, the second reference circuit is connected to a non-inverting input terminal of the third comparator, a source electrode of the field-effect transistor M3 is respectively connected to the resistor and an inverting input terminal of the third comparator, a drain electrode of the field-effect transistor M3 is connected to the output terminal of the second load, and the third comparator controls on and off state of the field-effect transistor M3 to control start and stop of the second load.

To achieve the above purpose, the present disclosure provides a constant current control system, including a drive module, a chip, and the above constant current drive circuit, the resistor R1 is connected to a pin VT1 of the chip, and the resistor R3 is connected to a pin CS of the chip, one terminal of the energy storage module is connected to an output terminal of the drive module, and the other terminal is connected to a pin CH of the chip, the load module includes a first load, a second load, and a resistor, an input terminal of the first load is connected to the drive module, and an output terminal of the first load is respectively connected to an input terminal of the second load and a pin OUT1 of the chip, an output terminal of the second load is connected to a pin OUT2 of the chip, and the resistor is connected to a pin REXT of the chip, the start-stop module includes a resistor R2, an input terminal of the resistor R2 is connected to the output terminal of the drive module, and the output terminal of the resistor R2 is respectively connected to a filter capacitor C1 and a pin VT2 of the chip.

Optionally, the drive module includes a rectifier bridge connected to a wire network and a diode D1, an output terminal of the rectifier bridge is connected to an input terminal of the diode D1, and the output terminal of the diode D1 is respectively connected to the resistor R2, the energy storage module, and the load module.

To achieve the above purpose, the present disclosure provides a lamp, including the above constant current drive circuit, and the load module is an LED lamp.

The beneficial effects of the present disclosure are as follows. The constant current drive circuit of this disclosure adjusts the current peak and current phase angle of the electrolytic capacitor E1 during charging or discharging through the rectifier module, enabling the output current of the constant current drive circuit to meet the requirements for phase angle and THD specified in the new national standard; the phase angle of the electrolytic capacitor E1 is adjusted by adjusting the resistance value of the resistor R1 to change the on or off time of the field-effect transistor M1; the adjustment of the current peak of the electrolytic capacitor E1 is realized by adjusting the resistance value of resistor R3.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate the technical solution of the present disclosure and not to limit the present disclosure. Although the present disclosure has been described in detail with reference to the examples, those of ordinary skill in the art should understand that the technical solution of the present disclosure can be modified or equivalently replaced without departing from the spirit and scope of the technical solution of the present disclosure.

1. A constant current drive circuit, comprising:
a load module;
a start-stop module, connected to an output terminal of the load module to control starting and stopping of the load module;
an energy storage module, connected to an input terminal of the load module to be charged when a first voltage is input to the load module and to be discharged when a second voltage is input to the load module, the first voltage being higher than the second voltage; and
a rectifier module, connected to an output terminal of the energy storage module to control a current angle and a current magnitude of a current flowing through the energy storage module;
wherein the rectifier module comprises a resistor R1, a first compensation circuit, a first reference circuit, a first comparator, a field-effect transistor M1, and a resistor R3, an input terminal of the resistor R1 is connected to the output terminal of the load module, and an output terminal of the resistor R1 is connected to an input terminal of the first compensation circuit, an output terminal of the first compensation circuit is connected to an input terminal of the first reference circuit, and an output terminal of the first reference circuit is connected to a non-inverting input terminal of the first comparator, an output terminal of the first comparator is connected to a gate electrode of the field-effect transistor M1, a drain electrode of the field-effect transistor M1 is connected to the energy storage module, a source electrode of the field-effect transistor M1 is connected to an inverting input terminal of the first comparator and an input terminal of the resistor R3, an output terminal of the resistor R3 is connected to the output terminal of the load module and to ground, to control a current peak value of the energy storage module through the resistor R3.

2. The constant current drive circuit according to claim 1, wherein the energy storage module comprises an electrolytic capacitor E1 and a resistor R4 connected in parallel with the electrolytic capacitor E1, a positive electrode of the electrolytic capacitor E1 is connected to the input terminal of the load module, and a negative electrode of the electrolytic capacitor E1 is connected to the drain electrode of the field-effect transistor M1, a resistance value of the resistor R1 is adjusted to control on and off state of the field-effect transistor M1, to change a current angle of the electrolytic capacitor E1 during charging and discharging.

3. The constant current drive circuit according to claim 1, wherein the rectifier module further comprises a temperature protector connected to the first reference circuit.

4. The constant current drive circuit according to claim 1, wherein the load module comprises a first load, a second load, and a resistor connected in series, the input terminal of the energy storage module is connected to an input terminal of the first load, the resistor R1 is connected to an output terminal of the second load, an input terminal of the resistor is respectively connected to output terminals of the first load and the second load, and an output terminal of the resistor is grounded.

5. The constant current drive circuit according to claim 4, wherein:
the start-stop module comprises a resistor R2, a filter capacitor C1, a second compensation circuit, a second reference circuit, a second switch circuit, and a third switch circuit, an input terminal of the resistor R2 is connected to the input terminal of the load module, and an output terminal of the resistor R2 is connected to input terminals of the filter capacitor C1 and the second compensation circuit, an output terminal of the filter capacitor C1 is grounded, the second compensation circuit is connected to the second reference circuit, an input terminal of the second switch circuit is connected to an output terminal of the first load, and
an output terminal of the second switch circuit is connected to the resistor to control start and stop of the first load, an input terminal of the third switch circuit is connected to the output terminal of the second load, and an output terminal of the third switch circuit is connected to the resistor to control start and stop of the second load, the second reference circuit generates a reference voltage and inputs the reference voltage to the second switch circuit and the third switch circuit to respectively control start and stop of the first load and the second load.

6. The constant current drive circuit according to claim 5, wherein:
the second switch circuit comprises a second comparator and a field-effect transistor M2, the second reference circuit is connected to a non-inverting input terminal of the second comparator, a source electrode of the field-effect transistor M2 is connected to the resistor and an inverting input terminal of the second comparator, a drain electrode of the field-effect transistor M2 is connected to the output terminal of the first load, and the second comparator controls on and off state of the field-effect transistor M2 to control start and stop of the first load.

7. The constant current drive circuit according to claim 5, wherein the third switch circuit comprises a third comparator and a field-effect transistor M3, the second reference circuit is connected to a non-inverting input terminal of the third comparator, a source electrode of the field-effect transistor M3 is connected to the resistor and an inverting input terminal of the third comparator, a drain electrode of the field-effect transistor M3 is connected to the output terminal of the second load, and the third comparator controls on and off state of the field-effect transistor M3 to control start and stop of the second load.

8. A constant current control system, comprising a drive module, a chip, and the constant current drive circuit according to claims 1, wherein:
the resistor R1 is connected to a pin VT1 of the chip, and the resistor R3 is connected to a pin CS of the chip, one terminal of the energy storage module is connected to an output terminal of the drive module, and the other terminal of the energy storage module is connected to a pin CH of the chip, the load module comprises a first load, a second load, and a resistor, an input terminal of the first load is connected to the drive module, and
an output terminal of the first load is connected to an input terminal of the second load and a pin OUT1 of the chip, an output terminal of the second load is connected to a pin OUT2 of the chip, and the resistor is connected to a pin REXT of the chip, the start-stop module comprises a resistor R2, an input terminal of the resistor R2 is connected to the output terminal of the drive module, and the output terminal of the resistor R2 is connected to a filter capacitor C1 and a pin VT2 of the chip.

9. The constant current control system according to claim 8, wherein the drive module comprises a rectifier bridge connected to a wire network and a diode D1, an output terminal of the rectifier bridge is connected to an input terminal of the diode D1, and the output terminal of the diode D1 is connected to the resistor R2, the energy storage module, and the load module.

10. A lamp, comprising the constant current drive circuit according to claim 1, and the load module is an LED lamp.
